(19) United States
(12) Patent Application Publication
(10) Pub. No.: US 2026/0220978 A1
(43) Pub. Date: Jul. 30, 2026

(54) METHOD FOR DETERMINING A WEAR INDICATOR FOR A VEHICLE, AND A VEHICLE

(71) Applicant: MERCEDES-BENZ GROUP AG, Stuttgart (DE)

(72) Inventors: Joana HOIS, Böblingen (DE); Alexander HANUSCHKIN, Karlsruhe (DE); Stefan STUDER, Stuttgart (DE)

(21) Appl. No.: 19/147,344

(22) PCT Filed: Dec. 20, 2023
(86) PCT No.: PCT/EP2023/086922

§ 371 Date: Jul. 11, 2025

(30) Foreign Application Priority Data
Jan. 12, 2023 (DE) 10 2023 000 076.0

(51) Int. Cl. G07C 5/00; G07C 5/04; G07C 5/08

(52) U.S. Cl. CPC G07C 5/008; G07C 5/006; G07C 5/04; G07C 5/085

(57) ABSTRACT

A wear indicator for a vehicle is determined using operating data constantly recorded by a vehicle over its lifetime. Operating data dependent on driving behavior and operating data dependent on settings of vehicle functions are aggregated in a use vector. Operating data representing environmental conditions of the vehicle is aggregated in an environment vector. The vehicle transmits the use and environment vectors to a vehicle-external central computing unit, which has access to a wear database correlating between the data that can be aggregated in the use vector and the data that can be aggregated in the environment vector regarding wear behavior of vehicle components. The use vector and the environment vector are compared to the wear database to determine a wear vector that considers the relation information. The central computing unit calculates the wear indicator using the vector elements of the wear vector.

### BACKGROUND AND SUMMARY OF THE INVENTION

Exemplary embodiments of the invention relate to a method for determining a wear indicator for a vehicle, and to a corresponding vehicle for carrying out the method.

A vehicle, such as a passenger car, is an everyday object that wears over time and in particular with heavy use. Exhausted windscreen washer fluid has to be refilled, the oil filter or the pollen filter has to be replaced, worn-out parts of the braking system or worn brake pads or corroded brake discs have to be replaced and similar. So that vehicles do not break down, vehicle maintenance is therefore carried out after a fixed specified maintenance period, such as for example every 30,000 kilometers or once per year. However, vehicles do not all wear in the same way, meaning that the fixed specified maintenance periods can be too early or too late. Typically, the maintenance periods are fixed with a sufficient buffer, so that there is not the risk of any problems in the case of standard vehicle usage. However, vehicle components are then possibly checked or changed unnecessarily often, although this is not necessary. There is also the danger that specific vehicle components are worn more than expected, which would require maintenance to be carried out earlier. Thus, there is the need to provide a method and means, which enable better estimation of when to carry out vehicle maintenance.

A method for predicting a maintenance date is known from WO 2022/012837 A1.

EP 2 674 343 A2 also discloses a method and an apparatus for determining the driving behavior of vehicle drivers. Parameters of the driver of the respective vehicle are collected during vehicle usage, with the aid of which the driving behavior can be described. For this purpose, the longitudinal and/or lateral acceleration acting on the vehicle is used as a parameter. The determined driving behavior characterization can be output in the vehicle, in order to encourage the driver to drive more defensively.

It can also be observed in everyday life that people deal differently with their own property than with that belonging to others. While usually a vehicle owner handles their own vehicle with care and drives gently, so that components wear comparatively slowly, less consideration is taken when using a rented vehicle or leased vehicle, for example. Among other things, this is due to the wear of a rented vehicle not having an impact for the person driving the vehicle, because they only use the rented vehicle temporarily and do not have pay directly for any maintenance costs.

Furthermore, DE 10 2016 221 086 A1 discloses a method for determining a wear and tear measure for a vehicle. A vehicle records data that describes its usage, which is evaluated by a server for determining the wear and tear measure. If there is a threat of failure of the vehicle due to an excessively worn vehicle component, a warning message shall be issued in good time to a user.

In addition, DE 10 2014 213 522 A1 discloses an apparatus and a method for determining strain profiles of motor vehicles. Similarly, here a server derives corresponding wear and tear parameters depending on operating variables collected by a motor vehicle. Among others, the operating time duration, the speed, the longitudinal and/or lateral acceleration, the engine speed and a respective standard deviation of the respective variable can be taken into consideration as operating variables.

Exemplary embodiments of the present invention are directed to an improved method for determining a wear indicator for a vehicle, with the aid of which the moment at which maintenance for a specific vehicle component is due can be determined particularly exactly.

A generic method for determining a wear indicator for a vehicle, wherein the vehicle constantly records operating data over its lifetime by means of monitoring members and at least some of the operating data is stored over the service life of the vehicle and is processed by a computing unit, wherein a part of the operating data is dependent on driving behavior of a person driving the vehicle, is further developed according to the invention in that
the part of the operating data dependent on the driving behavior and a part of the operating data dependent on settings of vehicle functions are aggregated in a use vector, wherein each vector element is assigned data generated by an individual monitoring member;
a part of the operating data representing environmental conditions of the vehicle is aggregated in an environment vector, wherein each vector element is assigned data generated by an individual monitoring member;
the vehicle transmits the use vector and the environment vector to a vehicle-external central computing unit, wherein the central computing unit has access to a wear database containing correlations between the data that can be aggregated in the use vector and the data that can be aggregated in the environment vector regarding wear behavior of vehicle components;
the central computing unit compares the use vector and the environment vector with the content of the wear database and determines a wear vector therefrom, wherein each vector element describes the degree of wear of an individual vehicle component; and
the central computing unit calculates the wear indicator by using the vector elements of the wear vector; and wherein
the central computing unit exchanges at least one vector element of the use vector for a corresponding, emulated vector element and determines an alternative wear vector and an alternative wear indicator based thereon and transmits these to the vehicle; wherein
the central computing unit transmits the wear indicator and the wear vector to the vehicle; and
the wear indicator and the alternative wear indicator and/or the value of at least one vector element of the wear vector and the alternative wear vector are output in the vehicle to the person driving the vehicle.

The wear indicator represents information which describes how heavily the vehicle is worn. Depending on the vehicle type and vehicle design, different reference values can be stored which are compared with the wear indicator. If the wear indicator is above or below these reference values, this can be understood as a sign to carry out maintenance. The individual vector elements of the wear vector describe the degree of wear of the individual vehicle components. The wear vector can, for example, have an entry for the spark plugs, a part of the exhaust system, the brake discs, the brake pads, the V-belt and similar as vector elements, which in each case are linked to a number. For example, this number can take the form of being between 0 and 10. In a factory-new vehicle, all values of the wear vector are 0 and increase with corresponding wear. Analogously, the wear indicator can be normalized, for example to a range between 0-1, 0-10 or 0-100.

Individual reference values can also be stored for different vector elements, so that the central computing unit can compare these vector element-specific reference values with the individual vector elements, and then the requirement to carry out maintenance can be determined when an individual vector element of the wear vector exceeds its corresponding reference value. The method according to the invention thus enables particularly precise estimation of the time at which a corresponding maintenance has to be carried out.

In this case, comprehensive influencing factors on the wear of the vehicle or the vehicle components are taken into consideration. For this purpose, the driving behavior of the person driving the vehicle counts as one. If the person driving the vehicle has a sportier driving style, the acceleration profiles are stronger, whereby tires and brake pads are worn faster, an oil particle filter is clogged faster, mechanical components wear out, and similar. Moreover, the settings of the vehicle functions made by the person driving the vehicle affect the wear of the vehicle components. If the person driving the vehicle has set a sporty switching profile, the automatic gearbox switches at higher speeds, whereby similarly the corresponding vehicle components wear out faster. If the person driving the vehicle prefers a higher fan setting and a cold interior, the air conditioning of the vehicle is also subjected to greater stress and also wears out more quickly. Then, for example, pollen filters have to be replaced faster or the coolant of the air conditioning has to be replaced or the line pipe of the air conditioning has to be checked for leakages. This information is aggregated in the use vector.

The vehicle uses monitoring members to record the operating data. These are sensors, such as acceleration sensors, temperature sensors, wheel speed sensors, flow meters and similar and also environmental sensors, such as cameras, laser scanners, radar sensors and ultrasound sensor systems. In addition, information, in particular setting parameters, processed by control devices, can be read out with the aid of the monitoring members. For this purpose, the monitoring members can be fixedly integrated into corresponding computing units, or can read out information transmitted via a data bus, such as a CAN bus. The monitoring members can record an opening degree of an electrical window lifter, a set seat position, a set fan level of an air conditioning system, an on-state of lighting apparatus and similar. For example, the operating time of individual light sources in the passenger compartment can be tracked and a change of corresponding light means can be proposed in good time when the service life of the light means comprised by the light sources will end soon.

The vector elements of the wear vector or the wear indicator itself can be multiplied with a cost factor, which allows for a cost estimating for carrying out the maintenance. In other words, this can be used to describe how much the value of the vehicle decreases due to wear and tear. This cost factor can be determined arbitrarily. For example, a cost factor of 0 can be used for the brake discs, when the respective vector element of the wear vector has such a low value that a replacement is not yet necessary. If the wear of the brake discs increases so that the vector element exceeds the respective reference value, the cost factor for the brake disc can increase from 0 to the actual current value of parts, which one has to pay for a replacement in the workshop, for example.

In this case, the central computing unit can individually track the wear vector or wear indicator for the individual vehicles of a vehicle fleet. For this purpose, a corresponding database can be stored in the central computing unit. If different people use one and the same vehicle, for example in the case of a leased vehicle or a rented car, the respective signs of wear by the individual use of the vehicles by the different people are taken into consideration. The central computing unit can be a cloud server, for example, also referred to as a backend. The central computing unit can be operated by the vehicle manufacturer, for example. Any radio technology is eligible for use for data exchange between the vehicle and central computing unit, such as, for example, mobile radio, WiFi, Bluetooth, ZigBee and similar. For this purpose, the vehicles can feature a wireless communication interface, for example formed by a telematics unit.

With the aid of the environment vector, the environmental conditions of the vehicle can be tracked over its service life. For example, it can be tracked that the vehicle is frequently used in the winter and/or in bad weather conditions, such as cold, rain or snow. This is an additional indicator for intensified wear due to humidity-related corrosion, in particular exacerbated by road salt. If the vehicle experiences frequent temperature fluctuations, for example because the vehicle is used in climatic regions where it is very warm during the day and very cold at night or in the winter in the cold, but is parked in a warm garage, these temperature fluctuations can also adversely affect the service life of individual vehicle components. Due to thermal expansion, gaps can be enlarged, or the viscosity of fluids leave their target range faster. The vehicle itself can determine environmental conditions not only by means of the sensors, but also from an external source. For example, the vehicle can wirelessly receive information from a traffic service or a weather service. If the vehicle determines that it is frequently driving in conditions during which the air is dusty or is loaded with pollen, this may have an effect on the clogging of the air filter of the vehicle. If the vehicle frequently drives in traffic congestion or slow-moving traffic, such as at rush hour, more start/stop processes are carried out by an automatic motor switching apparatus.

The wear database describes rules as to how the characteristics of the values of the wear vector are to be tracked over the service life depending on the information contained in the use vector and environment vector. If, for example, particularly many start and stop processes are carried out, severe braking maneuvers are carried out, in summer the vehicle is frequently parked in the blazing sun, and similar, the wear database describes how the respective vector elements of the wear vector have to be increased depending on these characteristics. The rules can be fixed or can also be implemented by machine learning methods. Approximations, heuristic equations, and machine learning models for comparing the use vector and the environment vector with the content of the wear database are all possible.

The vehicles of the vehicle fleet transmit their operating data over their service life to the central computing unit. The central computing unit tracks when exactly each maintenance work is carried out on the individual vehicles, and whether this was necessary, or has been carried out too late. Additionally, the incurred costs can be charged and stored as a reference. Taking into consideration this information, the central computing unit maintains the wear database and thus can always define newer rules as to how the entries of the use vector and the environment vector affect the wear vector. Along with defining new rules, existing rules can also be adapted.

Furthermore, there are different possibilities as to how the wear indicator is determined from the wear vector. For example, all vector elements can be summed up, an amount of the wear vector can be determined, the average of all the vector elements can be specified, a normalized wear vector can be calculated or similar.

The wear vector and the wear indicator are maintained on the central computing unit and managed. Thus, the central computing unit is able to track the wear for each vehicle of a vehicle fleet and, for example, determine workshop appointments for carrying out maintenance work in good time. Corresponding workshop appointments can also be booked automatically by the central computing unit.

It is provided that
the central computing unit transmits the wear indicator and the wear vector to the vehicle; and
the wear indicator and/or the value of at least one vector element of the wear vector in the vehicle is output to the person driving the vehicle.

By outputting the wear indicator and/or the value of at least one vector element of the wear vector in the vehicle, the person driving the vehicle can be informed about the degree of wear of the vehicle. This can be used to raise the awareness of the person driving the vehicle about the influence their usage behavior has on the wear of the vehicle. For example, it can be particularly clearly indicated to the person driving the vehicle how their driving behavior and the settings or usage behavior of vehicle functions apply to the wear. This causes the driver to adopt a more defensive driving behavior in order to slow down the wear and tear of the vehicle, thus minimizing maintenance costs. Similarly, the environmental conditions are also taken into consideration. If, for example, the person driving the vehicle frequently parks their vehicle in the blazing sun in summer, this can lead to faster ageing of the vehicle paint. Thus, information can be output to the person driving the vehicle to park their vehicle in the shade more frequently in summer. Thus, not only can the values of the wear indicator or the value of a vector element of the wear vector be output in the vehicle, but also supplementary alerts, which can lead to the slowing of wear of the vehicle. The output of information in the vehicle can take place via common means. Thus, for example, visual information output via display devices such as the instrument cluster, the head unit, a heads-up display, or similar is possible. An acoustic information output is possible via loudspeakers.

The usage behavior of the vehicle can also be tracked live by the vehicle during usage. The moment the person driving the vehicle behaves so that the vehicle is being excessively worn, for example due to a particularly hard acceleration or braking maneuver, information can be output in this moment alerting the person driving the vehicle of this damaging usage behavior. Here, haptic information output comes into consideration, such as the vibration of the steering wheel of the vehicle.

Preferably, there is a setting option, for example in the infotainment system of the vehicle, with which the person driving the vehicle can set to what degree they would like to be informed about the wear indicator or wear vector. Here, the person driving the vehicle can then also input whether information is to be output live.

The wear indicator or the wear vector of a respective vehicle can therefore also be provided to third-parties, for example by access via the central computing unit. The third-party may be a supplier of the vehicle manufacturer or a service provider, such as an insurance provider. The third-parties can process the information to be read out and can use it beneficially to adapt their business model.

It is also provided according to the invention that the central computing unit exchanges at least one vector element of the use vector for a corresponding, emulated vector element and determines an alternative wear vector and an alternative wear indicator based thereon and transmits these to the vehicle. This means that suggestions can be output to the person driving the vehicle as to how they can adapt their usage behavior of the vehicle in order to ensure less wear. For example, the longitudinal acceleration of the vehicle over time could be considered as a vector element. Then, an acceleration profile is provided as an emulated vector element, which in comparison contains smaller acceleration amplitudes, i.e., corresponds to a more defensive driving style. The central computing unit takes into consideration such an “emulated” use vector for calculating the alternative wear vector and alternative wear indicator. Accordingly, the alternative wear vector or alternative wear indicator will accept lower values, which are representative for a lower vehicle wear. This illustrates to the person driving the vehicle more particularly how they can advantageously change their usage, in order to slow down the wear of the vehicle and thus to also save costs.

According to an advantageous embodiment of the method, the vehicle identifies the person driving the vehicle, assigns them a person-specific user profile, and transmits this to the central computing unit, wherein the wear indicator is linked to the user profile. The vehicle or the central computing unit collects relation information, wherein relation information describes within which contractual framework conditions the person driving the vehicle uses the vehicle. The central computing unit then determines a relation information-specific wear indicator for each new item of relation information. By assigning an individual user profiles to the individual persons driving the vehicle, not only can the wear behavior of an individual vehicle be tracked by the central computing unit, but also even the influence of specific people can be taken into consideration.

The “relation” is particularly relevant for this, i.e., the relationship between the vehicle and the person driving the vehicle. As already explained above, the user often behaves so that rented or leased vehicles are worn out faster in comparison to their own vehicle. In order to take this into consideration, the relation information contains the following entries, for example: self-owned, third-party vehicle rental, third-party vehicle leasing, or similar.

If one and the same person change the vehicle, the person can be allocated an individual wear indicator for each vehicle. The relation information can be defined for this purpose as a vector, a matrix, or also as a rank-n tensor. For each first-time use of another vehicle, entries in the form of the relation information are attached to the corresponding vector, matrix, or tensor for this user profile. With time, more and more information about the user can be aggregated, which describes how the user uses different vehicles differently. With the aid of relation information, the usage history of a user can thus be tracked over different vehicles. The vector, the matrix, or the tensor can then describe that one and the same user has already driven three different vehicles belonging to themselves and already ten times a rented vehicle. Then a relation information-specific wear indicator is determined for each of these vehicles. This means that patterns can be recognized, for example, “small” wear indicators for the driver's own vehicles and “high” wear indicators for rented vehicles.

An embodiment of the relation information as tensor, for example as a second-order tensor (matrix), enables clear assignment of information. Then the relation between vehicle and user can be written in the first column of the relation information matrix, i.e., whether it is their own vehicle or a rented vehicle. In the second column, a driving style assessment based on the use vector is stored for this vehicle. In the third column, the relation-specific wear indicator can be stored. For each first-time newly used vehicle or when changing the contractual framework conditions, for example when a person takes over a leased vehicle, a new row is added to this matrix.

It is possible to identify people by means of common methods, such as registration by means of a user account and password, scanning biometric features, recognizing an identification token, for example on a carried vehicle key, or reading out a key parameter from a smartphone or similar.

Linking the wear indicator to the user profile can take place in the vehicle, or also be carried out by the central computing unit.

So that the vehicle can collect relation information, usually manual input is required by the person driving the vehicle. For this purpose, the vehicle can pro-actively ask the person driving the vehicle for input, for example via a vehicle-integrated human-machine interface, such as a touch-sensitive display or also via a mobile end device, which can be directly or indirectly coupled to the vehicle. Then a corresponding app can be executed on the mobile end device, by which the person driving the vehicle can input the relevant data. The mobile end device can then be connected to the internet by mobile radio and then in turn to the central computing unit. It is also conceivable that the person driving the vehicle logs on at home on a desktop computer or a tablet computer with a unique user profile onto a user account in the central computing unit and here inputs the relevant information via an input screen in the internet browser.

A relation information-specific wear indicator can be determined in the same way as a wear indicator. For this purpose, different approximation methods, heuristic equations or machine learning models are possible, which in each case work based on fixed rules.

Several relation information-specific wear indicators can be output simultaneously in the vehicle to one and the same user, for example in a direct comparison, which thereupon makes the corresponding user aware that they exhibit different usage behavior depending on the vehicle. It might not be obvious to some people that they drive a rented vehicle differently than their own vehicle.

Preferably, the central computing unit takes relation information into consideration as further influencing parameters for determining a characteristic of a respective relation information-specific wear indicator. As already explained, generally a relation information-specific wear indicator can be determined analogously to a wear indicator. For this purpose, the characteristics of the use vector and the environment vector are compared by the central computing unit with the wear database. As, typically, individual people behave differently with vehicles of a different relation, i.e., in their own vehicle compared to a rented vehicle, the respective relation-specific wear indicators will assume a different characteristic in the case of a different relation solely because the entries of the respective use vectors differ. However, the relation information itself can also be used as a further influencing factor to influence the result of the relation information-specific wear indicator.

Relation information can also be understood as a type of weighting factor. If it is an owned vehicle, the relation information-specific wear indicator can be multiplied by a comparatively low value, such as 0.5, for example. In contrast, if it is a rented vehicle or leased vehicle, multiplication by a comparatively high value, such as 1.5 or 3, can take place. This enables particularly fast and simple adaptation of the characteristic of the relation information-specific wear indicator.

In this case, the already calculated wear indicator does not necessarily have to be weighted, but the individual elements of the underlying relation information-specific wear vector can also be weighted.

According to a further advantageous embodiment of the method, the central computing unit determines a confidence value depending on a completeness of the use vector, environment vector, and/or the correlations stored in the wear database for each wear indicator, wherein the confidence value describes a high probability of being correct in the case of a comparatively complete use vector, environment vector, and/or wear database while determining a respective wear indicator, and describes a low probability of being correct in the case of a comparatively incomplete use vector, environment vector, and/or wear database. If a vehicle has only been used for a short time, at first only a small amount of information is available for the formation of the use vector and environment vector. Accordingly, a comparatively low confidence value is then determined. The confidence value can be output in the vehicle, so that the respective vehicle user is informed that although a wear indicator has been determined, it only has low significance. Analogously, specific correlations can be missing in the wear database.

In comparison, if the vehicle has been used by the person for longer, there is more information available in the use vector and environment vector. Accordingly, a higher confidence value is determined, which informs the person driving the vehicle that the significance of the wear indicator is already comparatively high.

A further advantageous embodiment of the method according to the invention provides that the central computing unit determines a relation information-specific alternative wear vector and alternative wear indicator and transmits these to the vehicle. Taking into consideration the relation information, an individual alternative wear vector and alternative wear indicator can be determined for each relation, i.e., each relationship of the user to different vehicles.

According to a further advantageous embodiment of the method according to the invention, the vehicle tracks a progression of at least one wear indicator, wear vector element, confidence value and/or an averaged wear indicator, wear vector element and/or confidence value over a time interval, compares a respective tracked value with a respective specified threshold and outputs an alert to the vehicle to carry out vehicle maintenance earlier if the tracked value is over the threshold and outputs the alert later if the tracked value is below the threshold. Thus, not only the central computing unit, but the vehicle itself is able to inform the person driving the vehicle or output recommendations when maintenance should be carried out.

This means that the time buffer or wear reserves can be reduced. Due to the increased accuracy as to when exactly maintenance is to be carried, the maintenance appointments can be temporally brought forward or pushed back depending on vehicle components. Thus, user comfort is increased, as vehicle components do not have to be unnecessarily replaced or vehicle components are replaced in good time. Therefore, a respective vector element of the wear vector can be specified for the wear indicator and an individual threshold can be specified for the confidence value or for values correspondingly averaged therefrom.

For example, it can be required to carry out an inspection once per year or every 15,000 kilometers. Then, it can be visually displayed in the vehicle in the 30 days before expiration of this year or in the 1,000 kilometers before reaching 15,000 kilometers that the inspection is to be carried out, for example when starting the vehicle. This information output can be omitted or take place earlier taking into consideration the wear vector or wear indicator. This information could also be supplemented by a description of which vehicle component has to be maintained in the inspection or maintenance period, such as for example changing the brake pads on the front axle, induced by the vector element of the wear vector, which exceeds its respective threshold.

A further advantageous embodiment of the method according to the invention also provides that the tracked values of a wear indicator, wear vector element, and/or confidence value, or variables averaged therefrom, are compared by the vehicle with a respectively specified threshold, whereupon the vehicle reduces a maximum available drive power and/or changes the control behavior of at least one driver assistance system to defensive behavior if the tracked value is over the threshold. In other words, if the vehicle detects usage behavior leading to increased wear, the vehicle can adapt the usability so that such states that lead to said increased wear can no longer be achieved in the vehicle's usage characteristic diagram. The reduction in the maximum drive power represents the simplest step in this case. However, the vehicle can adapt the behavior of the individual driver assistance systems, which provides even more scope to adopt a defensive driving behavior. For example, the minimum distance to a preceding vehicle can be enlarged in distance regulation cruise control, which leads to a longer braking distance being available in the case of emergency braking. This means that in the case of emergency braking, the vehicle has to brake less severely, which also causes the brakes to wear out less. The switching behavior of an automatic gearbox could also be changed. If the sport mode is activated by the person driving the vehicle, the speed thresholds for switching that are stored in the sport mode could be lowered. Then, gears are switched earlier in the sport mode, but not as early in the normal operating mode.

The temporal interval can be any size. Preferably, a comparatively long temporal interval, such as several weeks or months is taken into account, because short-term sporty driving styles are tolerated. This means that the user comfort is ensured, for example to be able to retrieve sufficient drive power in a dangerous situation in order to be able to overtake quickly.

In a vehicle having a vehicle-internal computing unit, a plurality of monitoring members and an interface for wireless data communication, according to the invention the computing unit, the monitoring members and the interface for wireless data communication are set up to perform the steps of a method described above that are to be carried out by the vehicle. The vehicle can be any vehicle, such as a car, lorry, van, bus or similar. The vehicle is thus able to determine the degree of wear of individual components and to plan on the basis thereof the carrying out of maintenance periods or workshop appointments, so that then a workshop visit is carried out exactly when this is actually required. Preferably, the vehicle can be designed to adapt its usability, so that those driving situations which contribute to heavier wear are avoided or the number thereof is at least reduced.

Further advantageous embodiments of the method according to the invention for determining a wear indicator for a vehicle also result from the exemplary embodiments which are described in more detail below with reference to the figures.

### BRIEF DESCRIPTION OF THE DRAWING FIGURES

Here the figures show:

FIG. 1 a schematic plan view of a vehicle according to the invention;

FIG. 2 a schematic representation of data processed by a computing unit; and

FIG. 3 a flow chart of a method according to the invention.

### DETAILED DESCRIPTION

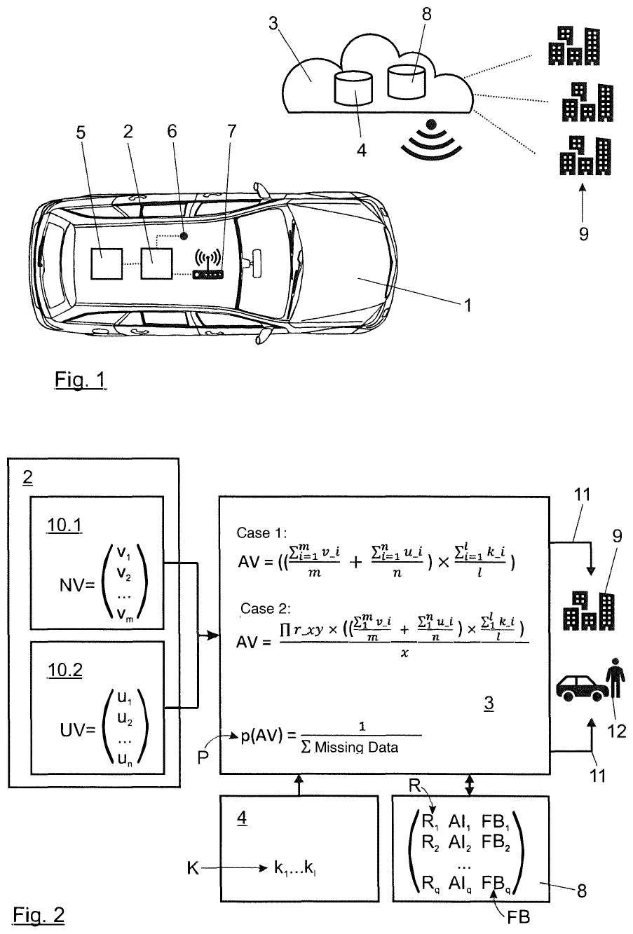

FIG. 1 shows a vehicle 1 according to the invention, comprising a computing unit 2, a control device 5, a sensor 6, and a telecommunications unit 7. The vehicle 1 or the computing unit 2 constantly records operating data over the lifetime of the vehicle 1. For this purpose, sensor data created by the sensor 6 is evaluated and data is read out from the control device 5. The computing unit 2 aggregates a part of the operating data dependent on the driving behavior and a part of the operating data dependent on settings of vehicle functions together in a use vector NV shown in FIG. 2. Additionally, the computing unit 2 aggregates operating data dependent on environmental conditions of the vehicle 1 to an environment vector UV, which is similarly shown in FIG. 2. The computing unit 2 transfers the use vector NV and the environment vector UV to a central computing unit 3, for example a cloud server, with the aid of the telecommunications unit 7.

The central computing unit 3 has access to a wear database 4. The wear database 4 can be integrated into the central computing unit 3, as shown. The wear database 4 could however also be designed externally to the central computing unit 3 and be communicatively connected to this. Correlations between data that can be aggregated in use vectors NV and data that can be aggregated in environment vectors UV for wear behavior of vehicle components are stored in the wear database 4. The central computing unit 3 compares the use vector NV and environment vector UV received by the vehicle 1 with the content of the wear database 4 and therefrom creates a wear vector AV, similarly shown in FIG. 2. In this case, each vector element of the wear vector AV describes the degree of wear of an individual vehicle component.

Different methods can be used for calculating the vector elements of the wear vector AV, such as approximation methods, heuristic functions, or machine learning models. The central computing unit 3 then calculates a wear indicator from the wear vector AV, which describes an evaluation of the entire degree of wear of the vehicle 1. The central computing unit 3 also includes a relation information storage device 8, in which relation information R is stored, which is similarly shown in FIG. 2. For this purpose, each driver of a vehicle 1 can be assigned a unique user profile in which the relation information R is stored. Relation information R is the relationship between the user and vehicle, for example whether the vehicle 1 belongs to the person driving the vehicle, is leased or rented by them or similar.

The wear indicator or wear vector AV determined by the central computing unit 3 can be transmitted back to the vehicle 1 and optionally to a third-party 9. For example, the third-party 9 may be a supplier of a vehicle manufacturer or a service provider, such as an insurance provider.

FIG. 2 shows data processed by the computing unit 2 and the central computing unit 3. The computing unit 2 includes a use data collection module 10.1 for aggregating the use vector NV and an environment data collection module 10.2 for aggregating the environment data for creating the environment vector UV.

The use vector NV includes different vector elements v₁, v₂, vₘ. For example, the vector element v₁, which could be representative of a battery consumption grade, takes a characteristic of 1 in a range from 1 to 10, which stands for very low consumption. The vector element v₂ could, for example, stand for the consumption of the air conditioning system and take a characteristic of 8, which stands for high consumption of a strongly cooled vehicle at a frequently maximum fan setting. An arbitrary other vector element could stand for a speed average, such as for example in town: 5, representative of an average speed, and out of town: 4, representative of an average speed.

The environment vector UV consists of vector elements u₁, u₂, uₙ. For example, the vector element u₁ stands for an average temperature in the vehicle's surroundings and, for example, can take a value of 3 in a range between 1 and 10, which stands for a normal range of the respective residence region of the vehicle 1. The vector element u₂ could, for example, stand for traffic volume and take a value of 3 for a low volume.

Parameters K are contained in the wear database 4, which describe a correlation between the respective characteristics of the use vector NV and of the environment vector UV to the degree of wear of vehicle components. These parameters K describe, for example, the tire wear, the battery ageing, the state of spark plugs, and similar. Similarly, a cost factor can be included, which can be multiplied with a wear factor, in order to predict costs incurred with maintenance of vehicle components. Thus, corresponding costs could also be individually determined for each vector element of the wear vector AV, or aggregated for the wear indicator.

Relation information R linked to user profiles are stored in the relation information storage device 8. For example, this could be stored as a matrix, as illustrated in FIG. 2. For example, the relation information R: R₁, R₂, and R_{q} is stored in the first column of the matrix. Then a relation information-specific wear indicator AI₁, AI₂, and AI_{q} is determined for a respective item of relation information R and stored. A further variable, such as for example driving style assessment FB₁, FB₂, and FB_{q}, which the central computing unit 3 can derive from the use vector NV can be saved in the third column. A respective variable contained in the matrix can then be taken into consideration for determining the wear vector AV or wear indicator.

FIG. 2 shows formulae taken into consideration by the central computing unit 3 by way of example. In Case 1, the determination takes place without taking into consideration relation information R, only based on the use vector NV and the environment vector UV. The index “m” corresponds to the number of elements of the vector elements of the use vector NV and “n” corresponds to the corresponding number of vector elements of the environment vector UV. In this case, “I” corresponds to the respective correlations stored in the wear database 4.

Case 2 describes the consideration of relation information R. The variable rxy stands for a respective matrix element from the matrix containing the relation information R. It can be iterated over all matrix elements or also only over a selection, for example over all column elements of the first column. The variable “x” would correspond to the number of rows of the matrix and “r_xy” would correspond to the individual items of relation information R₁, R₂, to R_{q}.

In the equations shown in FIG. 2, the first and second case are only examples. In general, different approximation equations or heuristic equations can also be used. Black box models can also be used as machine learning methods, such as using artificial neural networks.

In addition, the central computing unit 3 can determine a confidence value P depending on how many items of data there are in the use vector NV, the environment vector UV or correlations contained in the wear database 4. This represents a probability of how significant the determined wear indicator actually is. For example, to determine the confidence value P, the reciprocal value can be formed from the sum of the missing data. A relation information-specific confidence value can also be formed.

The variables calculated by the central computing unit 3 can then be output to vehicle occupants 12 and/or third-parties 9, as indicated by an arrow 11.

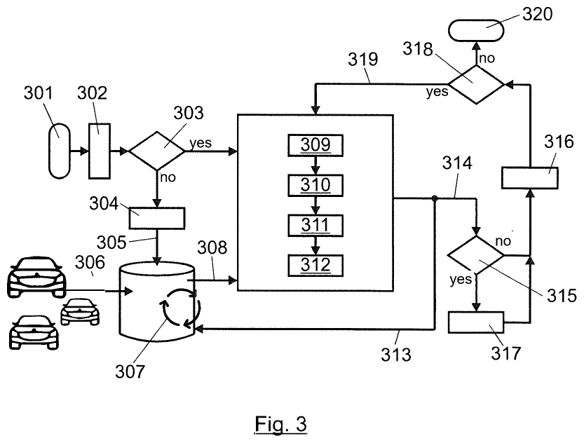

FIG. 3 illustrates the process of the method according to the invention. In method step 301, the method starts. In method step 302, the person driving the vehicle uses the vehicle 1 in a specific relation, i.e., for example, their own vehicle, a rented vehicle, the vehicle of a friend or acquaintance, or similar. In method step 303, the computing unit 2 or the central computing unit 3 checks whether the person driving the vehicle is to be assigned a unique user profile, and if this is the case, whether this already exists.

If a profile is not to be used or does not yet exist, in method step 304, the operating data is recorded while the vehicle 1 is being used and the corresponding use vectors NV and environment vectors UV are created. Furthermore, relation information can be collected.

In method step 305, the data thus created is transmitted to the central computing unit 3 for storage. In method step 306, the vehicles 1 of a vehicle fleet constantly transmit corresponding data. In this case, workshop costs and signs of wear and tear identified during maintenance can also be transmitted. In method step 307, this enables constant maintenance of the wear database 4. In method step 308, the present data of a respective vehicle 1 is available for the further calculation, with consideration being given to information determined in the past, where appropriate, for example relation-specific wear indicators calculated in the past.

In method step 309, the central computing unit 3 reads the use vector NV, the environment vector UV, the relation information R, and if necessary, further matrix elements of the matrix shown in FIG. 2. In method step 310, the central computing unit 3 retrieves historic operating data of the vehicle 1, i.e., operating data from the past. In method step 311, the central computing unit 3 calculates the wear vector and wear indicator and if necessary the confidence value P. Additionally, in method step 312 the central computing unit 3 calculates additional alternative wear vectors or alternative wear indicators, wherein for this purpose at least one vector element of the use vector NV used for calculating the wear vector is exchanged for an emulated value.

In method step 313, the thus calculated data is continually stored in the central computing unit 3. Therefore, the user profile of the person driving the vehicle can be maintained over time. For this purpose, the individual vector elements or matrix elements can be defined as time-dependent variables. Thus a respective vector or matrix element describes a time-dependent function.

In method step 314, the calculated results are transmitted back to the vehicle 1. The respective vehicle 1 or computing unit 2 then checks in method step 315 whether a critical threshold has been exceeded. If a critical threshold for at least one vector element of the wear vector or a threshold for the wear indicator exceeds a specific value, this means that a vehicle component shows too many signs of wear and tear. Based on this, the corresponding information can be acoustically and/or visually output in the vehicle 1 in method step 316. Additionally or alternatively, in method step 317, adaptation of vehicle functions can take place. Then, for example, the maximum retrievable drive power can be reduced, the minimum reliable distance from a vehicle driving in front can be enlarged for distance regulation cruise control, and similar.

In method step 318, the vehicle 1 checks whether it is currently being used. If this is the case, in method step 319 a cyclical recalculation based on current values takes place. In contrast, if this is not the case, the method ends in method step 320.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method comprising:
constantly recording, by a vehicle over a lifetime of the vehicle by monitoring components, operating data;
storing, by the vehicle, at least some of the operating data, wherein a part of the operating data is dependent on driving behavior of a person driving the vehicle;
aggregating, by the vehicle in a use vector, the part of the operating data dependent on the driving behavior and a part of the operating data dependent on settings of vehicle functions of the vehicle, wherein each use vector element of the use vector is assigned data generated by an individual one of the monitoring components;
aggregating, by the vehicle in an environment vector, a part of the operating data representing environmental conditions of the vehicle, wherein each environmental vector element is assigned data generated by an individual one of the monitoring components;
transmitting, by the vehicle to a vehicle-external central computing unit, the use vector and the environment vector, wherein the vehicle-external central computing unit has access to a wear database containing correlations between data that can be aggregated in the use vector and data that can be aggregated in the environment vector regarding wear behavior of vehicle components;
comparing, by the vehicle-external central computing unit, the use vector and the environment vector with content of the wear database;
determining, by the vehicle-external central computing unit based on the comparison of the use vector and the environment vector with the content of the wear database, a wear vector, wherein each wear vector element of the wear vector describes a degree of wear of an individual vehicle component;
calculating, by the vehicle-external central computing unit, a wear indicator using the wear vector elements of the wear vector;
exchanging, by the vehicle-external central computing unit, at least one of the use vector elements of the use vector for a corresponding, emulated vector element;
determining, by the vehicle-external central computing unit based on the exchanged corresponding emulated vector element, an alternative wear vector and an alternative wear indicator;
transmitting, by the vehicle-external central computing unit to the vehicle, the wear indicator and the alternative wear indicator; and
outputting, by the vehicle to a person driving the vehicle, the wear indicator and the alternative wear indicator, or a value of at least one of the wear vector elements of the wear vector and the alternative wear vector.

10. The method of claim 9, further comprising:
identifying, by the vehicle, the person driving the vehicle;
assigning, by the vehicle, the identified person driving the vehicle a person-specific user profile;
transmitting, by the vehicle to the vehicle-external central computing unit, the assigned person-specific user profile, wherein the wear indicator is linked to the person-specific user profile;
collecting, by the vehicle or the vehicle-external central computing unit, relation information describing which contractual framework conditions the person driving the vehicle uses the vehicle; and
determining, by the vehicle-external central computing unit, a relation information-specific wear indicator for each new item of relation information.

11. The method of claim 10, wherein the vehicle-external computing unit takes the relation information into consideration as further influencing parameters for determining a characteristic of a respective relation information-specific wear indicator.

12. The method of claim 9, further comprising:
determining, by the vehicle-external central computing unit, a confidence value for each wear indicator depending on a completeness of the use vector, environment vector, or the correlations stored in the wear database,
wherein the determined confidence value describes a high probability of being correct in case of a comparatively complete use vector, environment vector, or wear database while determining a respective wear indicator, and describes a low probability of being correct in case of a comparatively incomplete use vector, environment vector, or wear database.

13. The method of claim 10, further comprising:
determining, by the vehicle-external central computing unit, a relation information-specific alternative wear vector and alternative wear indicator; and
transmitting, by the vehicle-external central computing unit to the vehicle, the relation information-specific alternative wear vector and the alternative wear indicator.

14. The method of claim 9, further comprising the vehicle:
tracking a progression of at least one wear indicator, wear vector element, confidence value, averaged wear indicator, wear vector element, or confidence value over a time interval;
comparing a respective tracked value with a respective specified threshold; and
outputting an alert in the vehicle to carry out vehicle maintenance earlier when the tracked value is over the respective specified threshold and outputs the alert later when the tracked value is below the respective specified threshold.

15. The method of claim 9, further comprising the vehicle:
tracking a progression of at least one wear indicator, wear vector element, confidence value, averaged wear indicator, wear vector element, confidence value over a time interval;
comparing a respective tracked value with a respective specified threshold; and
reducing a maximum available drive power or changing control behavior of at least one driver assistance system of the vehicle to defensive behavior when the tracked value is over the respective specified threshold.

16. A system comprising:
a vehicle comprising a vehicle-internal computing unit, a plurality of monitoring components, and an interface for wireless data communication; and
a vehicle-external central computing unit operatively coupled to the interface of the vehicle to communicate data wirelessly,
wherein the vehicle is configured to constantly record, over a lifetime of the vehicle by the monitoring components, operating data,
wherein the vehicle is configured to store at least some of the operating data, wherein a part of the operating data is dependent on driving behavior of a person driving the vehicle,
wherein the vehicle is configured to aggregate, in a use vector, the part of the operating data dependent on the driving behavior and a part of the operating data dependent on settings of vehicle functions of the vehicle, wherein each use vector element of the use vector is assigned data generated by an individual one of the monitoring components,
wherein the vehicle is configured to aggregate, in an environment vector, a part of the operating data representing environmental conditions of the vehicle, wherein each environmental vector element is assigned data generated by an individual one of the monitoring components,
wherein the vehicle is configured to transmit, to the vehicle-external central computing unit, the use vector and the environment vector, wherein the vehicle-external central computing unit has access to a wear database containing correlations between data that can be aggregated in the use vector and data that can be aggregated in the environment vector regarding wear behavior of vehicle components,
wherein the vehicle-external central computing unit is configured to compare the use vector and the environment vector with content of the wear database,
wherein the vehicle-external central computing unit is configured to determine, based on the comparison of the use vector and the environment vector with the content of the wear database, a wear vector, wherein each wear vector element of the wear vector describes a degree of wear of an individual vehicle component;
wherein the vehicle-external central computing unit is configured to calculate a wear indicator using the wear vector elements of the wear vector,
wherein the vehicle-external central computing unit is configured to exchange at least one of the use vector elements of the use vector for a corresponding, emulated vector element,
wherein the vehicle-external central computing unit is configured to determine, based on the exchanged corresponding emulated vector element, an alternative wear vector and an alternative wear indicator,
wherein the vehicle-external central computing unit is configured to transmit the wear indicator and the alternative wear indicator to the vehicle, and
wherein the vehicle is configured to output, to a person driving the vehicle, the wear indicator and the alternative wear indicator, or a value of at least one of the wear vector elements of the wear vector and the alternative wear vector.
